(19) United States
(12) Patent Application Publication
(10) Pub. No.: US 2024/0254906 A1
(43) Pub. Date: Aug. 1, 2024

(54) CATALYTIC WALL FLOW FILTER

(71) Applicant: JOHNSON MATTHEY PUBLIC LIMITED COMPANY, London (GB)

(72) Inventors: Ketan Ravi CHAVDA, Royston (GB); Rui LI, Royston (GB); Sarah WARREN, Royston (GB)

(21) Appl. No.: 18/420,847

(22) Filed: Jan. 24, 2024

Related U.S. Application Data
(60) Provisional application No. 63/482,118, filed on Jan. 30, 2023.

(51) Int. Cl. F01N 3/10; B01J 6/00; B01J 23/40; F01N 3/022

(52) U.S. Cl. CPC F01N 3/103; B01J 6/001; B01J 23/40; F01N 3/0222; F01N 2570/12

(57) ABSTRACT

A catalytic wall-flow filter for exhaust gas from a gasoline engine is disclosed. The catalytic wall-flow filter comprises porous walls and having a first face and a second face defining a longitudinal direction therebetween and first and second pluralities of channels extending in the longitudinal direction. The first plurality of channels is open at the first face and closed at the second face, and the second plurality of channels is open at the second face and closed at the first face. The filter comprises a first coating in the first plurality of channels which is free of platinum group metal, and a second coating in the second channels which comprises palladium, platinum, an oxygen storage capacity material, and an inorganic support.

### TECHNICAL FIELD

The present invention relates to a catalytic wall-flow filter suitable for use in a vehicular automobile emission treatment system, in particular an emission treatment system for a positive ignition internal combustion engine, such as a gasoline spark ignition engine. In particular, the catalytic wall-flow filter can oxidize hydrocarbons and reduce particulate matter emissions.

### BACKGROUND OF THE INVENTION

Gasoline particulate filters (GPF) are an emission after-treatment technology developed to control particulate emissions from gasoline direct injection (GDI) engines.

The population of GDI vehicles has been increasing, driven by CO₂ and/or fuel economy requirements. In 2016, an estimated 60% of new gasoline cars in Europe were GDI. The proportion of GDI vehicles has been also rapidly increasing in North America-within nine years after its first significant use in the market, GDI penetration has climbed to 48.5% of new light vehicle sales in the United States. Emissions from the growing GDI vehicle fleet are a public health concern and a potential major source of ambient particle pollution in highly populated urban areas.

Most early GPF applications included an uncoated GPF positioned downstream of a three-way catalyst (TWC). As the technology matured, GPFs have been also coated with a three-way catalyst. This catalyst-coated GPF configuration is sometimes referred to as the four-way catalyst. However, the combination of the TWC coating on a filter body does introduce additional issues such as undue back-pressure, and there are requirements for minimum CO, NOx and HC conversion properties. In addition, there are cost considerations with a need to provide the best possible balance of performance to cost.

Three-way catalysts are intended to catalyze three simultaneous reactions: (i) oxidation of carbon monoxide to carbon dioxide, (ii) oxidation of unburned hydrocarbons to carbon dioxide and water; and (iii) reduction of nitrogen oxides to nitrogen and oxygen. These three reactions occur most efficiently when the TWC receives exhaust gas from an engine running at or about the stoichiometric point. As is well known in the art, the quantity of carbon monoxide, unburned hydrocarbons and nitrogen oxides emitted when gasoline fuel is combusted in a positive ignition (e.g., spark-ignited) internal combustion engine is influenced predominantly by the air-to-fuel ratio in the combustion cylinder. An exhaust gas having a stoichiometrically balanced composition is one in which the concentrations of oxidising gases (NOₓ and O₂) and reducing gases (HC and CO) are substantially matched. The air-to-fuel ratio that produces this stoichiometrically balanced exhaust gas composition is typically given as 14.7:1.

The active components in a typical TWC comprise one or both of platinum and palladium in combination with rhodium supported on a high surface area oxide, and an oxygen storage capacity (OSC) material.

Theoretically, it should be possible to achieve complete conversion of O₂, NOₓ, CO and HC in a stoichiometrically balanced exhaust gas composition to CO₂, H₂O and N₂ (and residual O₂) and this is the duty of the TWC. Ideally, therefore, the engine should be operated in such a way that the air-to-fuel ratio of the combustion mixture produces the stoichiometrically balanced exhaust gas composition.

A way of defining the compositional balance between oxidising gases and reducing gases of the exhaust gas is the lambda (λ) value of the exhaust gas, which can be defined according to the following equation:

lambda (λ)=(actual engine air-to-fuel ratio)/(stoichiometric air-to-fuel ratio)

wherein a lambda value of 1 represents a stoichiometrically balanced (or stoichiometric) exhaust gas composition, wherein a lambda value of >1 represents an excess of O₂ and NOx and the composition is described as “lean” and wherein a lambda value of <1 represents an excess of HC and CO and the composition is described as “rich”. It is also common in the art to refer to the air-to-fuel ratio at which the engine operates as “stoichiometric”, “lean” or “rich”, depending on the exhaust gas composition which the air-to-fuel ratio generates.

It should be appreciated that the reduction of NOₓ to N₂ using a TWC is less efficient when the exhaust gas composition is lean or stoichiometric. Equally, the TWC is less able to oxidize CO and HC when the exhaust gas composition is rich. The challenge, therefore, is to maintain the composition of the exhaust gas flowing into the TWC at as close to the stoichiometric composition as possible. Of course, when the engine is in steady state it is relatively easy to ensure that the air-to-fuel ratio is stoichiometric. However, when the engine is used to propel a vehicle, the quantity of fuel required changes transiently depending upon the load demand placed on the engine by the driver. This makes controlling the air-to-fuel ratio so that a stoichiometric exhaust gas is generated for three-way conversion particularly difficult. In practice, the air-to-fuel ratio is controlled by an engine control unit, which receives information about the exhaust gas composition from an exhaust gas oxygen (EGO) (or lambda) sensor: a so-called closed loop feedback system. A feature of such a system is that the air-to-fuel ratio oscillates (or perturbates) between slightly rich of the stoichiometric (or control set) point and slightly lean, because there is a time lag associated with adjusting air-to-fuel ratio. This perturbation is characterised by the amplitude of the air-to-fuel ratio and the response frequency (Hz).

When the exhaust gas composition is slightly rich of the set point, there is a need for a small amount of oxygen to consume the unreacted CO and HC, i.e., to make the reaction more stoichiometric. Conversely, when the exhaust gas goes slightly lean, the excess oxygen needs to be consumed. This was achieved by the development of OSC material that liberates or absorbs oxygen during the perturbations. The commonly used OSC material in modern TWCs is cerium oxide (CeO₂) or a mixed oxide containing cerium, e.g., a Ce/Zr mixed oxide.

It is known that Poly Aromatic Hydrocarbons (PAH) are present in both diesel and gasoline engine exhausts, see “Technical note: Emission factors, chemical composition, and morphology of particles emitted from Euro 5 diesel and gasoline light-duty vehicles during transient cycles,” Atmos. Chem. Phys., 21 (2021) 4779-4796. PAHs have been recognized as carcinogenic for humans. Exposure to PAHs is associated with excess risk of lung cancer as well as other adverse health effects including bronchitis, asthma, heart disease, and reproductive toxicity

There is a need to develop technologies to effectively oxidize hydrocarbons such as PAH and to reduce particulate matters in exhaust gas from a gasoline engine.

### SUMMARY OF THE INVENTION

One aspect of the present disclosure is directed to a catalytic wall-flow filter for exhaust gas from a gasoline engine, the catalytic wall-flow filter comprising porous walls and having a first face and a second face defining a longitudinal direction therebetween and first and second pluralities of channels extending in the longitudinal direction, wherein the first plurality of channels is open at the first face and closed at the second face, and wherein the second plurality of channels is open at the second face and closed at the first face;
wherein the filter comprises a first coating in the first plurality of channels;
wherein the filter comprises a second coating in the second channels;
wherein the second coating comprises a PGM selected from palladium and platinum, an oxygen storage capacity (OSC) material, and an inorganic support;
wherein the second coating is free of rhodium;
wherein the first coating is coated from the first face;
wherein the second coating is coated from the second face;
wherein the first face is an inlet face and the second face is an outlet face.

Another aspect of the present disclosure is a method for the manufacture of a catalytic wall-flow filter, the method comprising:
(a) providing a wall-flow filter substrate comprising porous walls and having a first face and a second face defining a longitudinal direction therebetween and first and second pluralities of channels extending in the longitudinal direction, wherein the first plurality of channels is open at the first face and closed at the second face, and wherein the second plurality of channels is open at the second face and closed at the first face;
(b) applying a first coating material in the first plurality of channels from the first face;
(c) applying a second coating material in the second plurality of channels from the second face, the second coating comprising a PGM selected from the group consisting of palladium and platinum and mixtures thereof, an oxygen storage capacity (OSC) material, and an inorganic support, wherein the second coating material is free of rhodium;
(d) calcining a coated wall-flow filter substrate obtained from steps (b) and (c) to produce the catalytic wall-flow filter.

Another aspect of the present disclosure is an emission treatment system for treating a flow of a combustion exhaust gas from gasoline direct injection engines, the system comprising the catalytic wall-flow filter as disclosed herein. Preferably the exhaust system comprises a TWC catalyst and the catalytic wall-flow monolith filter, wherein the TWC catalyst is upstream of the catalytic wall-flow monolith filter.

According to a further aspect, the invention provides a method of treating a combustion exhaust gas from a positive ignition internal combustion engine containing oxides of nitrogen, carbon monoxide, hydrocarbons, and particulate matter, which method comprising contacting the exhaust gas with the catalytic wall-flow filter as disclosed herein.

### DETAILED DESCRIPTION OF THE INVENTION

The present disclosure will now be described further. In the following passages, different aspects/embodiments of the disclosure are defined in more detail. Each aspect/embodiment so defined may be combined with any other aspect/embodiment or aspects/embodiments unless clearly indicated to the contrary. In particular, any feature indicated as being preferred or advantageous may be combined with any other feature or features indicated as being preferred or advantageous.

One aspect of the present disclosure is directed to a catalytic wall-flow filter for exhaust gas from a gasoline engine, the catalytic wall-flow filter comprising porous walls and having a first face and a second face defining a longitudinal direction therebetween and first and second pluralities of channels extending in the longitudinal direction, wherein the first plurality of channels is open at the first face and closed at the second face, and wherein the second plurality of channels is open at the second face and closed at the first face;
wherein the filter comprises a first coating in the first plurality of channels;
wherein the filter comprises a second coating in the second channels;
wherein the second coating comprises a PGM selected from palladium and platinum, an oxygen storage capacity (OSC) material, and an inorganic support;
wherein the second coating is free of rhodium;
wherein the first coating is coated from the first face;
wherein the second coating is coated from the second face;
wherein the first face is an inlet face and the second face is an outlet face.

Another aspect of the present disclosure is a method for the manufacture of a catalytic wall-flow filter, the method comprising:
(a) providing a wall-flow filter substrate comprising porous walls and having a first face and a second face defining a longitudinal direction therebetween and first and second pluralities of channels extending in the longitudinal direction, wherein the first plurality of channels is open at the first face and closed at the second face, and wherein the second plurality of channels is open at the second face and closed at the first face;
(b) applying a first coating material in the first plurality of channels from the first face;
(c) applying a second coating material in the second plurality of channels from the second face, the second coating comprising a PGM selected from the group consisting of palladium and platinum and mixtures thereof, an oxygen storage capacity (OSC) material, and an inorganic support, wherein the second coating material is free of rhodium;
(d) calcining a coated wall-flow filter substrate obtained from steps (b) and (c) to produce the catalytic wall-flow filter.

The wall-flow filter substrates are well known in the art. The wall-flow filter substrate has a first face (inlet face) and a second face (outlet face) defining a longitudinal direction therebetween and first and second pluralities of channels extending in the longitudinal direction. The first plurality of channels is open at the first face and closed at the second face and the channels of the first plurality of channels are defined in part by channel wall surfaces. The second plurality of channels is open at the second face and closed at the first face and the channels of the second plurality of channels are defined in part by channel wall surfaces. The channel walls between the channel wall surfaces of the first plurality of channels and the channel wall surfaces of the second plurality of channels are porous.

The wall-flow filter substrate can be a ceramic, e.g., silicon carbide, cordierite, aluminium nitride, silicon nitride, aluminium titanate, alumina, mullite, pollucite, or composites comprising segments of any two or more thereof. Cordierite, a magnesium aluminosilicate, and silicon carbide are particularly preferred.

The wall-flow filter substrate suitable for use in the present invention typically has a mean pore size of from 8 to 45 μm, for example 8 to 25 μm, or 10 to 20 μm. Pore size is well known in the art and appropriate measurement techniques are known to a person skilled in the art. The wall-flow filter substrate may have a porosity of 40 to 75%, such as 45 to 70%. The mean pore size may be determined using mercury porosimetry and x-ray tomography according to conventional methods.

The wall-flow monolith filter comprises a first coating in the first plurality of channels. The first coating comprises an inorganic material. Suitable inorganic material is selected from the group consisting of silica, alumina, zirconia, titania, zircon, cordierite, mullite, spinel, silicon carbide, silicon nitride, molecular sieves, and mixtures thereof. The molecular sieve can be a zeolite such as a silicate zeolite, an aluminosilicate zeolite, a metal-substituted aluminosilicate zeolite or a non-zeolitic molecular sieve, for example, an AlPO, a MeAlPO, a SAPO or a MeAPSO.

The first coating modifies the pore structure of the porous wall of the wall-flow monolith filter substrate so that it is more effective in capturing the particulate matter from the exhaust gas.

The mean particle size of the inorganic material can be in the range of 0.1 to 100 μm, preferably in the range of 0.1 to 50 μm.

The first coating loading can be in the range of 0.5 to 50 g/L, preferably 1 to 30 g/L. In certain embodiments, the first coating loading can be in the range of 0.5 to 10 g/L, or 10 to 30 g/L. The first coating loading is defined as the weight of the first coating relative to the total volume of the wall-flow filter after calcination.

The first coating may have a length that is 50 to 100% of the length of the first channels, preferably 80 to 100% of the length of the first channels, more preferably 90 to 100% of the length of the first channels. In certain embodiments, the first coating may have a length that is 40 to 60% of the length of the first channels.

The first coating may be an in-wall coating, an on-wall coating, or a combination of in-wall and on-wall coating.

In certain embodiments, the first coating is a microporous membrane that is formed in the first plurality of channels. Preferably the mean pore diameter of the membrane coating is in the range of 0.1 μm to 10 μm, preferably from 0.2 μm to 8 μm, and more preferably from 0.5 μm to 7 μm, from 0.75 μm to 6 μm, from 0.8 μm to 5 μm, from 1 μm to 4 μm, from 1.2 μm to 3 μm, from 1.5 μm to 2 μm, even more preferably from 1.6 μm to 1.8 μm.

The mean pore size of the microporous membrane can be measured by known techniques, e.g., by Hg intrusion Porosimetry (MIP) on a Micromeritics Autopore instrument.

The first coating may be applied to the first plurality of channels by applying a first coating material (e.g., a washcoat slurry) comprising the inorganic materials and a solvent. Typically the solid content in the washcoat slurry containing the inorganic materials is in the range of 10 to 35 wt %. Water is a preferred solvent for the washcoat slurry.

The washcoat slurry for the first coating may comprise an organic pore former. Examples of pore formers include cellulose, polyethylene, starch, graphite, polypropylene, polyaramides, polytetrafluoroethylene, polystyrene, cellulose fibres and polymethacryl-methacrylate, e.g., Arbocel, Vivapur, Mipelon PM-200, Propyltex, Orgasol and Remyrise.

The inorganic material and the pore former present in the washcoat slurry for the first coating can have a weight ratio of between 100:5 to 100:30.

In certain embodiments, the first coating is free of platinum group metal (PGM), for example, the amount of PGM in the first coating is less than 0.01 wt %, more preferably less than 0.001 wt %.

The first coating may be formed in the first plurality of channels by spraying an aerosol comprising the inorganic material dispersed in a gas, as taught by US20160310935A1 and US20220111376A1, teachings of which are hereby incorporated by reference in their entireties. The inorganic material may comprise one or more fumed refractory powders and or one or more aerogels. The one or more fumed refractory powders may be produced by a pyrogenic process, for example flame pyrolysis. The inorganic material may comprise one or more of fumed alumina, fumed silica, fumed titania, other fumed metal oxide and fumed mixed oxides. The inorganic material may comprise one or more of silica aerogel, alumina aerogel, titania aerogel, zirconia aerogel, ceria aerogel, a metal oxide aerogel, mixed oxide aerogels, and the like.

When the first coating material is applied to the first plurality of channels as an aerosol comprising the inorganic material dispersed in a gas, the aerogel may further comprise a silicone resin in powder form. Preferably, the silicon resin is a solid at room temperature (e.g., about 25° C.). Accordingly, the silicone resin preferably has a melting point of greater than 25° C., preferably greater than 30° C., more preferably greater than 35° C. Preferably, the melting point of the silicone resin is less than 100° C., preferably less than 95° C., less than 90° C., less than 85° C. or less than 80° C. Non-branched polysiloxanes such as PDMS typically have lower melting points than silicone resins which are branched. Preferably, the silicone resin has a glass transition temperature (Tg) of greater than 30° C., preferably greater than 35° C., and/or less than 100° C., preferably less than 80° C.

When the first coating material is applied to the first plurality of channels as an aerosol comprising the inorganic material dispersed in a gas, the first coating preferably covers the entire length of the first plurality of channels.

The catalytic wall-flow filter comprises a second coating in the second plurality of channels. The second coating comprises a PGM component selected from palladium and platinum, an oxygen storage capacity (OSC) material, and an inorganic support.

The second coating is free of rhodium.

The weight ratio of Pd to Pt present in the second coating may be from 1:10 to 10:1, preferably from 1:2 to 2:1.

The PGM loading (Pt and Pd) in the catalytic wall-flow monolith filter can be from 1 to 50 g/ft³, preferably from 2 to 40 g/ft³, more preferably from 3 to 35 g/ft³, even more preferably 4 to 30 g/ft³. In one particularly preferred embodiment, the PGM loading in the catalytic wall-flow monolith filter is 5 to 25 g/f³t.

The second coating comprises an oxygen storage capacity material. “Oxygen storage capacity” refers to the ability of materials used as oxygen storage capacity material in catalysts to store oxygen at lean conditions and to release it at rich conditions.

The OSC material can be ceria or a mixed oxide comprising ceria. Preferably the OSC material comprises a mixed oxide of cerium, zirconium; a mixed oxide of cerium, zirconium, and aluminium; a mixed oxide of cerium, zirconium, and neodymium; or a mixed oxide of cerium, zirconium and praseodymium. The term “mixed oxide” as used herein generally refers to a mixture of oxides in a single phase, as is conventionally known in the art.

The amount of the OSC material in the second coating can be from 5 to 90 wt %, preferably from 10 to 80 wt %, relative to the total weight of the second coating.

The second coating comprises an inorganic oxide support. The inorganic oxide support can be an oxide of Groups 2, 3, 4, 5, 13 and 14 elements. The inorganic oxide support is preferably a refractory oxide that exhibits chemical and physical stability at high temperatures, such as the temperatures associated with gasoline engine exhaust. The inorganic oxide support can be selected from the group consisting of alumina, silica, titania, and mixed oxides or composite oxides thereof. More preferably, the inorganic oxide support is an alumina.

The inorganic oxide support such as alumina can be doped with a dopant. The dopant can be selected from the group consisting of La, Sr, Si, Ba, Y, Pr, Nd, Ce, and mixtures thereof. Preferably, the dopant is La, Ba, or Ce. Most preferably, the dopant is La. The dopant content in the inorganic oxide support can be from 1 to 30 wt %, preferably from 2 to 25 wt %, more preferably from 3 to 20 wt %.

The OSC material and the inorganic oxide support in the second coating can have a weight ratio of from 10:1 to 1:10, preferably from 5:1 to 1:5, more preferably from 3:1 to 1:3.

The second coating may be performed by spraying and/or dipping the wall-flow filter substrate with a second coating material (e.g., a second washcoat slurry). One suitable coating procedure is described in WO1999047260.

The second coating may cover from 10% to 100% of the length of the second plurality of channels, preferably from 20 to 90%, more preferably 30 to 80% of the length of the second plurality of channels.

The second coating material comprises a platinum group metal component consisting of Pt and Pd. Suitable precursors of Pt and Pd include salts containing these metals, e.g., platinum nitrate and palladium nitrate.

The second coating material typically contains water as a solvent. Other solvents or mixtures of water and other solvents such as alcohols may be used.

The second coating material typically has a solid content of from 15 to 40%, more preferably 20 to 35%, by weight.

The second coating material may comprise a rheology modifier. Suitable examples of rheology modifies include polymers such as long chain polysaccharides, polyethylene glycol derivatives (PEGs) and acrylic polymers. One preferred rheology modifier is a hydroxyethylcellulose (available from Ashland as Natrosol).

Generally, the second coating material may comprise a rheology modifier in the amount of 0.1 to 1.0 wt %, preferably 0.2 to 0.9 wt %, more preferably 0.3 to 0.8 wt % relative to the total weight of the second coating material.

The second coating material preferably has a viscosity of from 1000 to 2000 cP, more preferably from 1200 to 1800 cP, most preferably from 1400 to 1600 cP, as measured at 20° C. on Brookfiled TM RV DVII+Extra Pro viscometer using a SC4-27 spindle at 50 rpm spindle speed

The second coating may be an in-wall coating, an on-wall coating, or a combination of in-wall and on-wall coating. Preferably, the second coating is primarily on-wall.

The first coating material may be applied to the wall-flow filter substrate before or after the application of the second coating material.

After one or both of the first coating material and the second coating material is applied to the wall-flow filter substrate, it is preferable to dry and/or calcine the wall-flow filter substrate containing one coating before another coating is applied. Calcining may be preceded by a drying step at a lower temperature (such as 100 to 200° C.). Calcining is routine in the art and may be performed under usual conditions.

Another aspect of the present disclosure is an emission treatment system for treating a flow of a combustion exhaust gas from gasoline direct injection engines, the system comprising the catalytic wall-flow monolith filter as disclosed herein. The exhaust system can comprise additional components, such as a TWC catalyst containing a TWC composition applied to a honeycomb flow-through substrate and disposed either upstream or downstream of the catalytic wall-flow filter according to the invention.

Preferably the exhaust system comprises a TWC catalyst and the catalytic wall-flow filter as disclosed herein, wherein the TWC catalyst is upstream of the catalytic wall-flow filter.

The catalytic wall-flow filter is effective in reducing particulate emissions and hydrocarbons such as polyaromatic hydrocarbons in the exhaust gas.

According to a further aspect, the invention provides a method of treating a combustion exhaust gas from a positive ignition internal combustion engine containing oxides of nitrogen, carbon monoxide, hydrocarbons, and particulate matter, which method comprising contacting the exhaust gas with the catalytic wall-flow filter as disclosed herein.

### EXAMPLE 1

Step A. The inlet channels of a cordierite wall-flow honeycomb filter substrate (300 cells per square inch; mean pore size 17 μm; porosity 66%) are loaded with a mixture of calcium aluminate powder (d50=53 μm, d90=118 μm) and a highly cross-linked ethoxylated poly(dimethyl siloxane) powder (silicon dioxide content of 82 wt %, melting point of from 35° C. to 55° C., d50=34 μm, d90=115 μm) at a weight ratio of 1:1 using the method and apparatus described in WO 2021/028692. The diameter of the flow conduit is the same as the inlet face of the filter. A primary gas flow of 550 m³/h of air is pulled through the filter using a downstream regenerative blower. Back pressure is monitored with a Wika® P30 pressure transmitter located below the filter. The refractory powder is dispersed into the primary gas flow using a STAR Professional gravity feed spray gun 1.4 mm part no. STA2591100C. The 15 STAR Professional gravity feed spray gun was mounted 100 mm from the inlet face of the filter. The back pressure is used to determine the point of stopping of spraying of the refractory powder. After loading is completed, the filter is calcined at 500° C. for 1 h.

Step B. A washcoat slurry containing Pd nitrate, Pt nitrate, a cerium-zirconium mixed oxide nano sol (mean particle size 390 nm), a gamma phase alumina (mean particle size 5 μm), a hydroxyethylcellulose (0.6 wt % relative to the total weight of the washcoat slurry), and water is prepared. The slurry has a solid content of 25% and a viscosity of about 1500 cP, as measured at 20° C. on Brookfiled TM RV DVII+Extra Pro viscometer using a SC4-27 spindle at 50 rpm spindle speed.

Step C. The washcoat slurry prepared in Step B is coated from the outlet face of the cordierite wall-flow filter substrate prepared in Step A using a coating procedure described in GB2524662. A pre-determined amount of the slurry is deposited at the outlet end of the filter substrate using a slurry dosing head. The dosing head has a plurality of apertures arranged to dispense the slurry onto the upper end face of the filter substrate. The channels having open ends at the outlet end of the filter substrate are coated with the pre-determined amount of the slurry by applying a vacuum to the inlet end of the filter substrate to draw the slurry along the channels. The coating length on the outlet channels is about 50% of the channel length. The coated substrate is dried at 110° C., and calcined at 500° C. The catalytic wall-flow filter thus produced is expected to have a washcoat loading of 0.2 g/in³ in the outlet channels, Pt loading of 16 g/ft³, and Pd loading of 4 g/ft³.

1. A catalytic wall-flow filter for exhaust gas from a gasoline engine, the catalytic wall-flow filter comprising porous walls and having a first face and a second face defining a longitudinal direction therebetween and first and second pluralities of channels extending in the longitudinal direction,
wherein the first plurality of channels is open at the first face and closed at the second face, and wherein the second plurality of channels is open at the second face and closed at the first face;
wherein the filter comprises a first coating in the first plurality of channels;
wherein the filter comprises a second coating in the second channels;
wherein the second coating comprises a PGM selected from the group consisting of palladium, platinum, and mixtures thereof, an oxygen storage capacity (OSC) material, and an inorganic support;
wherein the second coating is free of rhodium;
wherein the first coating is coated from the first face;
wherein the second coating is coated from the second face;
wherein the first face is an inlet face and the second face is an outlet face.

2. The catalytic wall-flow filter of claim 1, wherein first coating comprises an inorganic material.

3. The catalytic wall-flow filter of claim 2, wherein the inorganic material is selected from the group consisting of silica, alumina, zirconia, titania, zircon, cordierite, mullite, spinel, silicon carbide, silicon nitride, molecular sieves, and mixtures thereof.

4. The catalytic wall-flow filter of claim 1, wherein the first coating loading is in the range of 0.5 to 100 g/L

5. The catalytic wall-flow filter of claim 1, wherein the first coating is a microporous membrane.

6. The catalytic wall-flow filter of claim 1, wherein the first coating is formed in the first plurality of channels by spraying an aerosol comprising the inorganic material dispersed in a gas.

7. The catalytic wall-flow filter of claim 1, wherein the second coating covers from 30 to 80% of the length of the second plurality of channels.

8. The catalytic wall-flow filter of claim 1, having a PGM loading of 5 to 25 g/ft³.

9. A method for the manufacture of a catalytic wall-flow filter, the method comprising:
(a) providing a wall-flow filter substrate comprising porous walls and having a first face and a second face defining a longitudinal direction therebetween and first and second pluralities of channels extending in the longitudinal direction, wherein the first plurality of channels is open at the first face and closed at the second face, and wherein the second plurality of channels is open at the second face and closed at the first face;
(b) applying a first coating material in the first plurality of channels from the first face;
(c) applying a second coating material in the second plurality of channels from the second face, the second coating comprising a PGM selected from the group consisting of palladium and platinum and mixtures thereof, an oxygen storage capacity (OSC) material, and an inorganic support, wherein the second coating material is free of rhodium;
(d) calcining a coated wall-flow filter substrate obtained from steps (b) and (c) to produce the catalytic wall-flow filter.

10. The method of claim 9, wherein the second coating material comprises a rheology modifier.

11. The method of claim 10, wherein the rheology modifier is a hydroxyethylcellulose in 0.3 to 0.8 wt % relative to the total weight of the second coating material.

12. The method of claim 9, wherein the second coating material has a viscosity of from 1400 to 1600 cP, as measured at 20° C. on Brookfiled TM RV DVII+Extra Pro viscometer using a SC4-27 spindle at 50 rpm spindle speed

13. An emission treatment system for treating a flow of a combustion exhaust gas from gasoline direct injection engines, the system comprising the catalytic wall-flow filter of claim 1.

14. A method of treating a combustion exhaust gas from a positive ignition internal combustion engine containing oxides of nitrogen, carbon monoxide, hydrocarbons, and particulate matter, which method comprising contacting the exhaust gas with the catalytic wall-flow filter of claim 1.
